(19) United States
(12) Patent Application Publication
(10) Pub. No.: US 2009/0272150 A1
(43) Pub. Date: Nov. 5, 2009

(54) CORROSION-RESISTANT CRADLE AND CASTABLE MATERIALS FOR GLASS PRODUCTION

(76) Inventors: Lawrence Henry Kotacska, Big Flats, NY (US); Ralph A. Langensiepen, Corning, NY (US); James Patrick Murphy, Corning, NY (US)

Correspondence Address: CORNING INCORPORATED, SP-TI-3-1, CORNING, NY, 14831, US

(21) Appl. No.: 12/256,088

(22) Filed: Oct. 22, 2008

Related U.S. Application Data
(60) Provisional application No. 61/001,621, filed on Nov. 2, 2007.

(51) Int. Cl. C03B 5/00

(52) U.S. Cl. 65/374.12

(57) ABSTRACT

A cradle for a high-temperature fluid delivery system, comprising a shell including a base and two side walls defining a trough, wherein the shell comprises fused zirconia. Fused zirconia provides the high temperature creep-resistance, corrosion resistance and thermal insulation to supported delivery system. The cradle extends system life, increases product quality and reduces costs associated with failure of glass delivery system.

### CROSS-REFERENCED TO RELATED APPLICATIONS

This application claims the benefit of priority to U.S. provisional application of 61/001621 filed on Nov. 2, 2007, the content of which is incorporated herein by reference in its entirety.

### TECHNICAL FIELD

The present invention relates to high temperature material delivery components and systems. In particular, the present invention relates to corrosion-resistant cradle and castable material for refractory metal glass delivery systems. The present invention is useful e.g., in the glass melting and delivery systems employing refractory noble metal vessels, such as those made of Pt and Pt alloys.

### BACKGROUND

The current direct heat platinum system (“DHPS”) used for glass delivery is prone to glass leaks and other material failures if the system operates at a temperature close to the melting temperature of the metal for a prolonged period of time. The cascading effect of a glass leak and other material failures results in premature shutdown of the glass production line. To prevent and/or mitigate the failure of a platinum glass delivery system, castable materials and cradles are needed to support the platinum pipelines.

The glass transport system of jointed, self-heated precious metal, like platinum alloy, operates at a temperature very close to the melting point of the metal. As such, these thin glass transport structures are very prone to deformation under the load of the glass. In the event of a rupture in the precious metal plumbing, calcium aluminate cement bonded castable and alumina cradle materials undergo appreciable dissolution when they are exposed to certain boroaluminosilicate glass compositions. At this point both castable and cradles lose their function: the castable is unable to contain the leak and the cradle loses its structural integrity. Once the structural integrity of the cradle is lost, it can no longer support the precious metal glass transport system and a more pronounced glass leak will occur. The glass migrates outside of the castable and cradle assembly and into the surrounding insulation refractories. This condition increases heat loss and forces the DHPS power to maximum output. When the maximum output is reached, there is no longer enough power to heat the glass sufficiently to remove blisters or the glass transport vessel may undergo catastrophic failure.

An exemplary process for manufacturing glass articles begins with the melting of raw feed materials, such as metal oxides, to form a molten glass. The melting process not only results in the formation of glass, but also the formation of various unwanted by-products, including various gases such as oxygen, carbon dioxide, carbon monoxide, sulfur dioxide, sulfur trioxide, argon, nitrogen, and water. Unless removed, these gases can continue throughout the manufacturing process, ending up as small, sometimes microscopic gaseous inclusions or blisters in the finished glass article.

For some glass articles, the presence of small gaseous inclusions is not detrimental. However, for other articles of manufacture, gaseous inclusions as small as 50 μm in diameter are unacceptable. One such article is the glass sheet used in the manufacture of display devices such as liquid crystal and organic light emitting diode displays. For such applications, the glass must have extraordinary clarity, pristine surfaces, free of distortion and inclusions.

To remove gaseous inclusions from the molten glass, a fining agent or agents are typically added to the feed material. The fining agent can be a multivalent oxide, such as As₂O₃. As₂O₃ is converted into As₂O₅ during glass melting process. During fining stage, the following reaction occurs:

As₂O₅→As₂O₃+O₂ (gas)

The released oxygen forms gas bubbles in the molten glass. The gas bubbles allow other dissolved gases to be collected and rise to the surface of the melt, where it is removed from the process. The heating is typically performed in a high temperature fining vessel.

Typical fining temperatures for display-grade glasses can be as high as 1700° C. Temperatures this high require the use of specialized metals or alloys to prevent destruction of the vessel. Platinum or platinum alloys, such as platinum-rhodium are typically used. Platinum advantageously has a high melting temperature and does not easily dissolve in the glass. Nevertheless, at such high temperatures, the platinum or platinum alloy readily oxidizes. Therefore, steps must be taken to prevent contact between the hot platinum fining vessel and atmospheric oxygen.

Moreover, because platinum is a precious metal and quite expensive, the walls of the fining vessel are generally manufactured as thinly as possible. Thus, the fining vessel may further require physical support in the form of a cradle and castable.

In the event that the fining vessel develops a glass leak, the cradle and castable act as a secondary containment for the glass. Therefore, the compatibility between the glass and the cradle and castable materials must be considered in order to prevent corrosion of the support structure.

### SUMMARY

Embodiments of the same or differing aspects of the present invention described summarily and in detail below may combine, where possible and applicable, to form various additional embodiments.

According to the first aspect of the present invention, provided is a cradle for a high-temperature fluid delivery system, comprising a shell including a base and two side walls defining a trough, wherein the shell comprises fused zirconia.

In certain embodiments of the first aspect of the present invention, the shell consists essentially of fused zirconia.

In certain embodiments of the first aspect of the present invention, the base of the shell has high creep resistance at the operating temperature of the high-temperature fluid delivery system.

In certain embodiments of the first aspect of the present invention, the shell has the structure of a unitary body.

In certain embodiments of the first aspect of the present invention, the fused zirconia has a low open-pore porosity.

In certain embodiments of the first aspect of the present invention, the fused zirconia is essentially impervious to a non-corrosive liquid at a temperature of 1000° C., in certain embodiments at a temperature of 1200° C., in certain embodiments at a temperature of 1500° C., in certain embodiments at a temperature of 1600° C., in certain embodiments at a temperature of 1650° C.,

In certain embodiments of the first aspect of the present invention, the cradle is for supporting a refractory vessel such as piping operable to deliver a fluid having a temperature higher than 1000° C., in certain embodiments higher than 1500° C., in certain embodiments higher than 1600° C.

In certain embodiments of the first aspect of the present invention, the cradle is for supporting a refractory metal piping operable to deliver a molten glass.

In certain embodiments of the first aspect of the present invention, the fused zirconia has a density of at least 4.8 g·cm⁻³, in certain embodiments at least 5.0 g·cm⁻³, in certain other embodiments at least 5.2 g·cm⁻³, in certain embodiments at least 5.3 g·cm⁻³.

In certain embodiments of the first aspect of the present invention, the shell comprises at least 90% by weight of ZrO₂; in certain embodiments at least 91%, in certain other embodiments at least 92%, in certain embodiments at least 93%.

In certain embodiments of the first aspect of the present invention, the trough has a depth such that it is operable to contain a refractory piping in which the fluid level is lower than the highest point of the trough.

In certain embodiments of the first aspect of the present invention, the cradle further comprises, inside the shell, a cast refractory material operable to support the high-temperature fluid delivery system.

According to a second aspect of the present invention, provided is a glass manufacturing system comprising:
a refractory metal vessel operable to contain molten glass;
a cradle comprising a fused-zirconia-containing shell at least partially enclosing the metal vessel, wherein the shell includes a base and two side walls defining a trough; and
a bedding of cast refractory material disposed between the external surface of the metal vessel and the shell.

In certain embodiments of the second aspect of the present invention, the refractory metal vessel comprises platinum and/or an alloy thereof.

In certain embodiments of the second aspect of the present invention, the bedding of cast refractory material substantially fills in the gap between the cradle and the external surface of the metal vessel.

In certain embodiments of the second aspect of the present invention, the glass manufacturing system is operable to handle a molten glass at a temperature of 1500° C., in certain embodiments 1550°, in certain embodiments 1600°, in certain embodiments 1650° C., in certain embodiments 1670° C.

In certain embodiments of the second aspect of the present invention, the thickness of the wall of the metal vessel is less than 10 mm, in certain embodiments less than 5 mm, in certain embodiments less than 3 mm.

In certain embodiments of the second aspect of the present invention, the refractory material of the bedding is corrosion-resistant with respect to a molten aluminoborosilicate glass at its fining temperature.

In certain embodiments of the second aspect of the present invention, the shell has the structure of a unitary body.

In certain embodiments of the second aspect of the present invention, the metal vessel comprises a metal pipe.

In certain embodiments of the second aspect of the present invention, the cradle comprises a cover over the pipe and the cradle, which in certain embodiments comprises fused zirconia.

In certain embodiments of the second aspect of the present invention, the glass manufacturing system comprises a liner material between the pipe and the cover substantially filling in the gap between the pipe and the cover. In certain specific embodiments, the liner comprises cast zirconia.

In certain embodiments of the second aspect of the present invention, the external surface of the metal vessel is substantially protected from being exposed to oxygen during operation thereof.

In certain embodiments of the second aspect of the present invention, the glass manufacturing system comprises a DHPS system.

Certain embodiments of the present invention have one or more of the following advantages. First, fused zirconia is corrosion-resistant to the molten glass. In case of glass leak from the metal vessel, the cradle can still offer robust support to the vessel, preventing early failure of the system. Second, the corrosion-resistant fused zirconia cradle, along with the bedding material between the cradle and the vessel, and the optional cover of the cradle and top filler material, provide good thermal insulation for the metal vessel, therefore maintaining a substantially uniform temperature of the vessel, reducing power needed to heat the vessel, and enhancing the quality of the glass contained in the vessel by reducing defects caused by non-uniform temperatures or low temperature.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that the foregoing general description and the following detailed description are merely exemplary of the invention, and are intended to provide an overview or framework to understanding the nature and character of the invention as it is claimed.

The accompanying drawing is included to provide a further understanding of the invention, and is incorporated in and constitutes a part of this specification.

### BRIEF DESCRIPTION OF THE DRAWING

In the accompanying drawings:

FIG. 1 is a schematic illustration of the cross-sectional view of a cradle according to one embodiment of the present invention enclosing a refractory metal pipe containing molten glass.

### DETAILED DESCRIPTION

As used herein, “a unitary body” means a body having a structure wherein the geometric sections of the body form a single peace without the use of a bonding agent or means. Typically, in a unitary body, chemical compositions of the materials in adjacent parts of the body are continuous. In certain embodiments, chemical compositions of the materials in adjacent parts of the body are essentially identical. Thus, a continuous ring of fused zirconia produced by melting zirconia and casting the molten zirconia in a ring-shaped mold has a unitary body; a body comprising two identical rings of fused zirconia stacked one over the other, joined by refractory binding materials differing from the ring materials, does not have the structure of a unitary body.

In high-temperature material processing, such as metallurgy, glass melting processes, high temperature liquids, such as molten metal, molten glass, and the like, are frequently contained, transported or dispensed via a vessel, such as a crucible, a melter, a pipe, a mold, a stirrer, a finer, a reactor, and the like. Refractory materials are used to construct such vessels. In the context of glass making processes, including but not limited to fusion downdraw processes, float processes, slot draw processes, and the like, precious metals such as Pt and Pt alloys are frequently employed to construct such vessels. In certain embodiments, the vessels are built in such a way that it can be directly electrically heated by passing an electrical current through its wall. Such a vessel, when comprising Pt, is sometimes referred to as Directly Heated Pt System (DHPS).

Because of the high cost of precious metals, the vessels are typically built with a wall as thin as possible. Such thin-wall vessels tend to have insufficient mechanical strength to withstand the weight of the molten material contained therein for a sufficient period of time without deformation and/or failure at the typical operating temperature which can be close to the melting point of the metal forming the vessel. Therefore, a supporting means, such as a cradle, holding the vessel in place during operation, is necessary to maintain the integrity and functionality of the vessel.

High temperature cement and refractory bricks were frequently used in constructing the supporting means. Such high refractory materials used included alumina bricks, zircon bricks, fused alumina, and calcium aluminate castables. However, in the context of glass manufacture, it has been found that cradles made of these materials alone are not robust enough, especially in area where the glass melt is at the highest temperature close to the melting temperature of metal of the vessel wall. For one thing, these materials have insufficient creep resistance at such high operating temperatures, tend to sag over time, leading to the deformation of the vessel, stress in the vessel wall, and eventually breakage of the vessel, and leakage of molten glass. For another thing, these materials tend to have insufficient corrosion-resistance against molten oxide glasses at such high operating temperatures. Therefore, minor leakage of molten glass corrodes the cradle structure quickly, resulting in the weakening of the cradle structure, and possibly catastrophic failure of the whole glass processing system. In addition, in certain embodiments, it is highly desirable that the vessel is thermally insulated by the cradle to that the molten glass is maintained at a high temperature to allow for the production of glass with desired quality. For example, in the glass fining zone, where the molten glass is allowed to degas, the molten glass is heated to an elevated temperature, such that the glass viscosity is sufficiently low to allow bubbles to rise, and the glass undergoes chemical reactions essentially for the fining process.

Therefore, the cradle material and construction design thereof can affect the life of the previous metal vessels, the productivity of the glass making system, and the life of the glass making system. There is a strong interest in constructing a cradle with high creep-resistance (or low creep rate) at the operating temperature, ability to contain minor leakage, resistant to molten glass, and provide sufficient thermal and oxygen insulation for a sufficient period of time.

Disclosed herein are materials for a cradle and castable system which can be used as a part of a DHPS glass making/processing system used in the production of glass. The materials (fused zirconia cradle and partially stabilized zirconia castable, e.g.) exhibit high strength and creep resistance as well as corrosion resistance to aluminoborosilicate glass compositions; and are, therefore, able to support the castable-bedded alloy finer/delivery system and contain glass in the event of a leak.

It is highly desired that the base of the cradle shell comprises fused zirconia which exhibits a high strength, low creep and high corrosion-resistance against molten oxide glass materials. The base of the cradle shell supports a large portion of the weight of the whole system, including the cradle shell itself any castable included in the shell, the metal vessel and any material such as molten glass contained therein. In certain embodiments, it is desired that the shell has a unitary body structure, where the side walls and the base join together to form a seamless unitary peace. The base, the side walls, and the unitary piece, may be produced by fusing zirconia articles, along with additives at various amounts, into a near-net-shape cradle shell, or a fused zirconia block followed by machining.

The cradle shell may take various shapes, such as partial egg shell, a cubic block with an open cavity, and the like. In certain embodiments, the cradle shell takes the shape of a trough. The vessel containing high temperature fluid, such as a crucible, a pipe, a finer, a reactor, a stirrer, and the like, is enclosed in the shell, the cavity or the trough. The shell may be further supported or fixed by additional structures, such as a shelf, a pedestal, railings, and the like.

In certain embodiments, especially in the case of a glass making system, it is highly desirable that the fused zirconia material for the cradle shell has a low level of open pore porosity. Open pores are vulnerable to molten glass penetration. In certain embodiments, the fused zirconia material comprises less than 10% by volume of open pores, in certain embodiments less than 8%, in certain embodiments les than 5%, in certain embodiments less than 3%.

In certain embodiments, it is desired that the fused zirconia material for the cradle shell has a density of at least 4.8 g·cm⁻³, in certain embodiments at least 5.0 g·cm⁻³, in certain embodiments at least 5.2 g·cm⁻³, in certain embodiments at least 5.3 g·cm⁻³. Typically, the higher the density of the fused zirconia material, the lower the percentages of the pores contained therein. Zirconia has a theoretical maximal density of 5.89 g·cm⁻³ under standard conditions.

The fused zirconia material for the cradle shell may comprise, in addition to ZrO₂, additional refractory components at a minor portion. Such additional refractory components may include, e.g., Al₂O₃, TiO₂, Fe₂O₃, CaO, and the like. However, it is desired that the cradle shell material comprises, in majority, ZrO₂. In certain embodiments, the shell material comprises at least 90% by weight of ZrO₂, in certain embodiments at least 91%, in certain embodiments at least 92%, in certain embodiments at least 93%.

The cradle according to the present invention may be employed in high temperature fluid delivery systems with a maximal operating temperature suitable for handling a non-corrosive fluid at 1000° C., in certain embodiments at 1200° C., in certain embodiments at 1500° C., in certain embodiments at 1550° C., in certain embodiments at 1600, in certain embodiments at 1650° C. Desirably, the cradle shell is essentially impervious to such non-corrosive high-temperature fluid.

Desirably, the cast cement material between the shell and the fluid delivery apparatus is essentially insoluble when exposed to the high-temperature fluid inside vessel. In certain embodiments, a desirable candidate material for the cast cement (or bedding material) is a zirconia castable. Calcium aluminate bonded castable may be employed in certain embodiments. However, in the case of molten oxide glass delivery systems, calcium aluminate is not as corrosion-resistant as zirconia castables.

In certain embodiments of the cradle and glass manufacturing system, the highest fluid level inside the refracatory vessel is lower than the highest point of the side walls of the vessel shell. In certain embodiments, the refractory vessel is completed enclosed inside the cradle shell. These arrangements have the capability to provide better support to the vessel and better containment of any leaked fluid from the vessel.

The bottom line advantage of the invention is the large cost savings. Based on less down time, capital avoidance, and higher selects, substantial savings can be effected by using the cradle and glass-making system according to the present invention, especially in fusion draw processes.

The glass-making system of the present invention further has the following additional advantages: higher quality glass based on a reduction in defects can be produced.

The system has reduced deformation of precious metals that ultimately results in glass leaks.

Even in the unlikely event of a metal vessel leakage, the system can still contain the glass, reducing catastrophic glass leakage.

Calcium aluminate bonded castable and porous alumina cradle are not optimal for use in DHPS for glass delivery due to their corrosion behavior when in contact with certain molten aluminoborosilicate glass compositions. Alumina refractory materials were found to exhibit sufficient creep resistance at use temperatures to prevent gross deformation in use. A bedding material, such as a calcium aluminate cement bonded fused alumina castable is a high strength, creep resistant bedding material applied by wet casting between the alloy and the refractory cradle. If the bedding material is cast without large voids or other casting defects, the system can be adequately supported at operating temperatures.

However, when contacted with leaked molten glass, these materials are quickly dissolved, allowing for material removal at the leak site and beyond as dissolved refractory is transported by the leaking glass. The support of the system is therefore compromised, leading to deformation of the alloy and the potential for large-scale failure of the system. A system that exhibits both high strength and creep resistance as well as corrosion resistance to our glass compositions is needed.

We tested corrosion resistant zirconia castable with fused zirconia cradle materials for the DHPS. The experimental findings indicate these materials can successfully extend the life of precious metal glass delivery systems that operate at high temperature in oxidizing atmospheres. Fused zirconia exhibits superior sag resistance with respect to Al₂O₃ and calcium aluminate materials and is resistant to corrosion by glass, and is effectively impermeable to glass leaks. Therefore, fused zirconia can replace creep resistant alumina as a cradle material to support the castable-bedded alloy finer/delivery system.

Partially stabilized zirconia castables that employ a fugitive acetate bonding system can serve as a corrosion resistant bedding material between the precious metal alloy system and the fused zirconia cradle material. Once a ceramic bond has formed during the temperature ramp from cure to operating temperature, the cement free castable exhibits equivalent sag resistance to fused alumina castable bonded with calcium aluminate cement, and superior performance relative to insulating castables such as bonded bubble alumina product. Its main benefit is that the zirconia castable is not dissolved by the glass; thereby the castable retains its ability to support the alloy system and prevent deformation and alloy tears which increase the total leak rate.

In certain embodiments of the glass-making system of the present invention, it comprises: (i) a refractory cradle defining a trough with sidewalls extending upward from the trough wherein the cradle material is generically known as fused zirconia, with the cradle being cast from the melt in a single piece; (ii) a bed of castable refractory disposed between the vessel and the cradle, the castable refractory surrounding the vessel and comprising a neck above the vessel; wherein the castable is composed of partially stabilized zirconia grains with a fugitive binder of zirconium acetate; and (iii) additional refractories disposed above the cradle comprising fused zirconia.

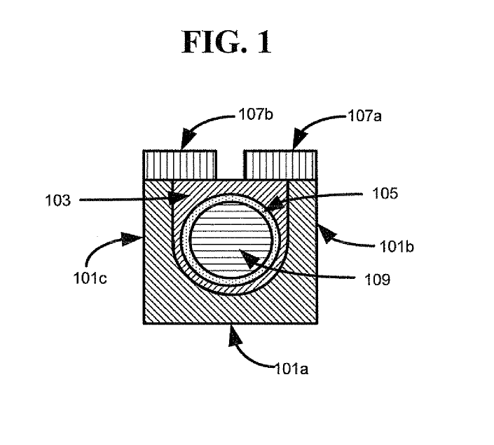

Referring to FIG. 1, the system 100 according to one embodiment of the present invention comprises a cradle including a base 101a, two side walls 101b and 101c extending upwards, which together form a unitary body. The single-piece cradle can be made by melting zirconia powder to obtain a zirconia melt, then casting the melt in a mold. A refractory metal pipe 105, such as a glass finer made of Pt or Pt—Ru alloy, is enclosed inside the cradle. During operation of the system, the pipe may contain molten glass 109. The molten glass 109 may fill the internal cavity of the whole pipe 105, or a part thereof, leaving some empty space in the top portion. Disposed between the internal surface of the cradle and the external surface of the metal pipe 105 is cast cement. The cast cement can be calcium aluminate, cast alumina, cast zirconia, and the like. In certain embodiment, the cast cement completely encloses the pipe, providing mechanical support and thermal insulation to the pipe. In certain embodiments, the cradle is further covered by covers 107a and 107b which are made of refractory materials such as zirconia, zircon and alumina. It is desired that the gap between the cover 107a and 107b and the external surface of the pipe 105 are covered by cast cement, so that the whole pipe is thermally insulated. The fused zirconia cradle provides the creep resistance, high temperature resistance and corrosion resistance of the whole structure lacking in conventional cradles made of Al₂O₃ and calcium aluminate alone.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

1. A cradle for a for a refractory vessel in a high-temperature fluid delivery system, comprising a shell including a base and two side walls defining a trough, wherein the shell comprises fused zirconia.

2. A cradle according to claim 1, wherein the shell consists essentially of fused zirconia.

3. A cradle according to claim 1, wherein the base of the shell has high creep resistance.

4. A cradle according to claim 1, wherein the shell has the structure of a unitary body.

5. A cradle according to claim 1, wherein the fused zirconia has a low open-pore porosity.

6. A cradle according to claim 1, wherein the fused zirconia is essentially impervious to a non-corrosive liquid at a temperature of 1000° C.

7. A cradle according to claim 1, which is for supporting a refractory vessel such as piping operable to deliver a fluid having a temperature higher than 1000° C., in certain embodiments higher than 1500° C., in certain embodiments higher than 1600° C.

8. A cradle according to claim 1, wherein the refractory vessel is a refractory metal piping operable to deliver a molten glass.

9. A cradle according to claim 1, wherein the fused zirconia has a density of at least 4.8 g·cm⁻³.

10. A cradle according to claim 1, wherein the shell comprises at least 90% by weight of ZrO₂.

11. A cradle according to claim 1, wherein the trough has a depth such that it is operable to contain a refractory piping in which the fluid level is lower than the highest point of the trough.

12. A cradle according to claim 1, further comprising, inside the shell, a cast refractory material operable to support the high-temperature fluid delivery system.

13. A glass manufacturing system comprising:
a refractory metal vessel operable to contain molten glass;
a cradle comprising a fused-zirconia-containing shell at least partially enclosing the metal vessel, wherein the shell includes a base and two side walls defining a trough; and
a bedding of cast refractory material disposed between the external surface of the metal vessel and the shell.

14. A glass manufacturing system according to claim 13, wherein the refractory metal vessel comprises platinum and/or an alloy thereof.

15. A glass manufacturing system according to claim 13, wherein the bedding of cast refractory material substantially fills in the gap between the cradle and the external surface of the metal vessel.

16. A glass manufacturing system according to claim 13, operable to handle a molten glass at a temperature of 1500° C.

17. A glass manufacturing system according to claim 13, wherein the thickness of the wall of the metal vessel is less than 10 mm.

18. A glass manufacturing system according to claim 13, wherein refractory material of the bedding are corrosion-resistant with respect to a molten aluminoborosilicate glass at its fining temperature.

19. A glass manufacturing system according to claim 13, wherein the shell has the structure of a unitary body.

20. A glass manufacturing system according to claim 13, wherein the metal vessel comprises a metal pipe.

21. A glass manufacturing system according to claim 19, further comprising a cover over the pipe and the cradle, which in certain embodiments comprises fused zirconia.

22. A glass manufacturing system according to claim 21, comprising a liner material between the pipe and the cover substantially filling in the gap between the pipe and the cover.

23. A glass manufacturing system according to claim 22, wherein the liner comprises fused zirconia.

24. A glass manufacturing system according to claim 13, wherein the surface of the metal vessel is substantially protected from being exposed to oxygen during operation thereof.

25. A glass manufacturing system according to claim 13, comprising a DHPS system.
